(19) United States
(12) Patent Application Publication
(10) Pub. No.: US 2008/0143672 A1
(43) Pub. Date: Jun. 19, 2008

(54) Immobile computer input device for generating a cursor-moving or scrolling signal

(75) Inventors: Zhen-Bang Chen, Taipei (TW); Qin-Yu Fu, Taipei (TW)

Correspondence Address: BACON & THOMAS, PLLC, 625 SLATERS LANE, FOURTH FLOOR, ALEXANDRIA, VA, 22314, US

(73) Assignee: KYE SYSTEMS CORPORATION, Taipei (TW)

(21) Appl. No.: 11/653,336

(22) Filed: Jan. 16, 2007

(30) Foreign Application Priority Data
Dec. 13, 2006 (TW) 095146749

(51) Int. Cl. G06F 3/033

(52) U.S. Cl. 345/157

(57) ABSTRACT

An immobile or stationary computer input device includes a body having at least a button, a trace-detecting module having a light transmitting element at one side and a detecting unit at an opposite side, and a switching unit. A micro-controller respectively couples to the button, the trace-detecting module and the switching unit, such that the trace-detecting module alternatively generates a cursor-moving signal or a scrolling signal when the switching unit is activated.

### BACKGROUND OF THE INVENTION

1. Field of the Invention

The present invention relates to a computer input device, and in particular to an immobile or stationary input device for generating the cursor-moving and scrolling signals.

2. Description of the Prior Art

Due to the limited space on a desk top, a variety of input devices have been introduced in this field to enable a user to finish his daily work with the least tools in hand, and the least hand or finger movements.

A trackball is an example of an immobile input device, but the “marked ball” used therein is bulky and inconvenient, especially for business travel. Examples of popular trackballs include the Cordless Optical TrackMan®, and Cordless TrackMan® Wheel, which are made by Logitech®.

In addition to being bulky, the above-mentioned conventional immobile input devices can not provide both cursor-moving and scrolling functions.

### SUMMARY OF THE DISCLOSURE

It is an object of the present invention to provide a relatively inexpensive immobile input device for operating a computer such that the immobile input device can generate a cursor-moving signal or a scrolling signal.

It is another object of the present invention to provide a protective cover for protecting a trace-detecting module of the input device.

To accomplish the advantage mentioned above, the invention comprises a body having at least a button, a trace-detecting module having a light transmitting element at one side and a detecting unit at an opposite side, and a switching unit. A micro-controller respectively couples to the button, the trace-detecting module, and the switching unit, and the trace-detecting module alternatively generates a cursor-moving signal or a scrolling signal once the switching unit is activated.

### BRIEF DESCRIPTION OF THE DRAWINGS

FIG. 1 is the block diagram of the present invention.

FIG. 2 is an exploded perspective view of a preferred embodiment of the present invention.

FIG. 3 is another exploded perspective view of the preferred embodiment.

FIG. 4A is a perspective view of the preferred embodiment in a protective position.

FIG. 4B is a perspective view of the preferred embodiment in an operating position.

FIG. 5A is a perspective view of the preferred embodiment in use.

FIG. 5B is a cross-sectional side view of the preferred embodiment in use of FIG. 5A.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

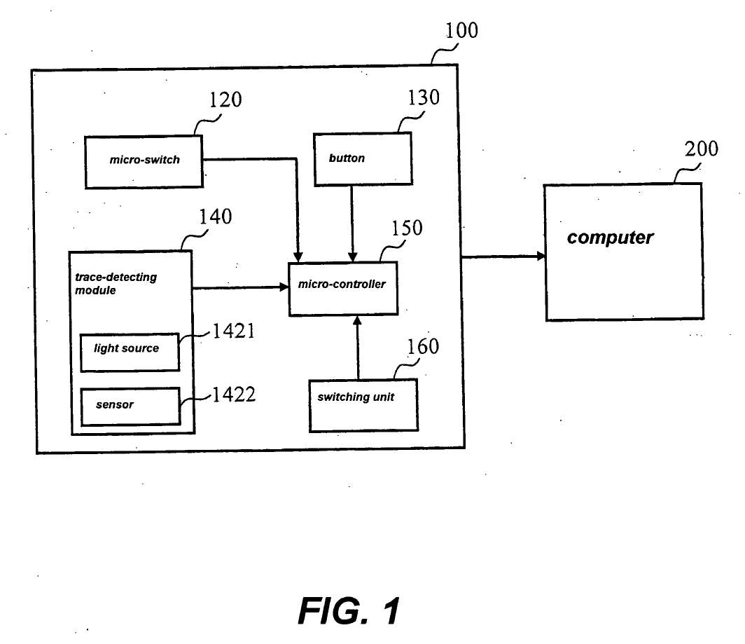

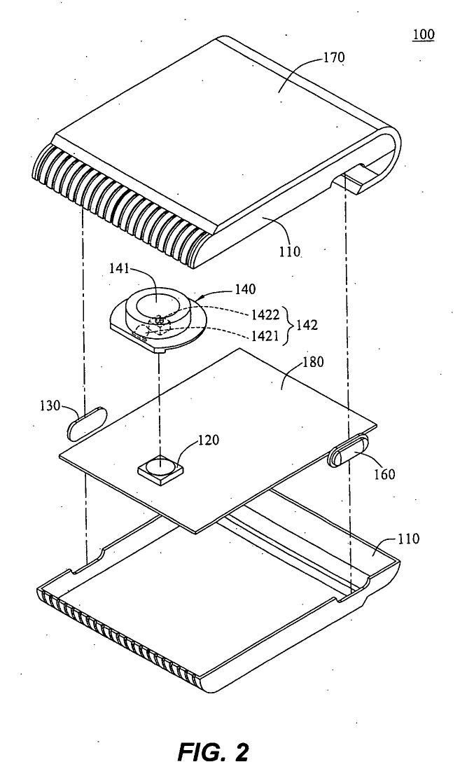

Referring to FIGS. 1 and 2, the immobile input device 100 has a body 110 which further has a micro-controller 150, at least a button 130, a switching unit 160 and a trace-detecting module 140. The micro-controller 150 respectively couples to the button 130, trace-detecting unit 140 and the switching unit 160.

Referring to FIGS. 1, 4, 5 A and 5B, the trace-detecting module 140 has a light transmitting element 141 and a detecting unit 142 on the circuit board 180. The detecting unit 142 comprises a light source 1421 and a sensor 1422. The light transmitting element 141 is at a first side, and a light source 1421 and a sensor 1422 are at a second side such that the light source 1421 projects light beams toward the light transmitting element 141 and the sensor 1422 receives reflected light from the light transmitting element 141 when a user's finger or other object contacts and moves upon the light transmitting element 141. Therefore, according to this embodiment, the trace-detecting module 140 will generate a first predetermined signal indicative of finger movement, which may for example be a cursor-moving signal.

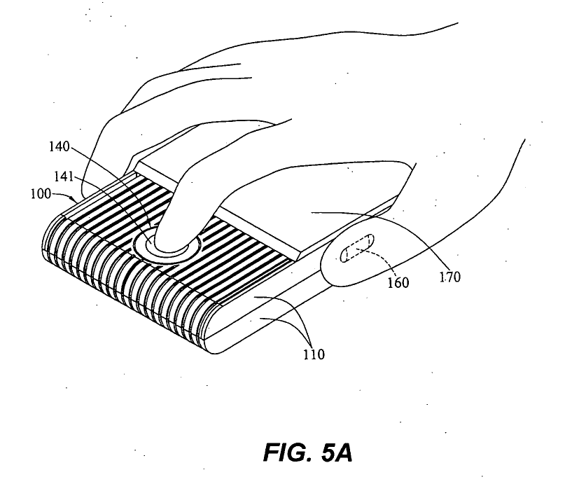

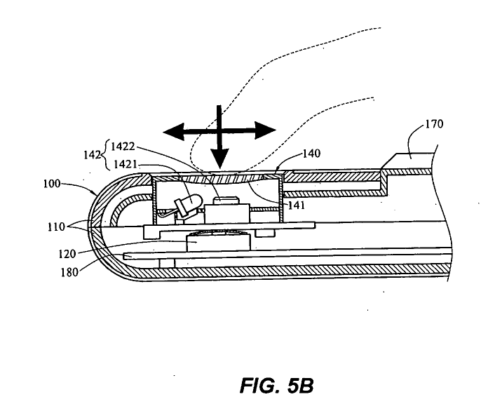

Referring to FIGS. 2A and 5A, the micro-controller 150 further couples to a micro-switch 120 which is located under the trace-detecting module 140. In other words, the trace-detecting module 140 can be supported by a micro-switch 120. Once the user's finger depresses the trace-detecting module 140, the micro-switch 120 will execute a predetermined function or command. Once the user releases or disengages from the light transmitting element 141, the trace-detecting module 140 will return to its original position.

Referring to FIGS. 1, 2, and 5A, once the user activates the switching unit 160, movement of the user's finger while in contact with the light transmitting element 141 will generate a second predetermined signal, such as a scrolling signal, instead of the previous cursor-moving signal. Alternatively, the user may press the switching unit 160 and moving his finger on the trace-detecting module 140 simultaneously, or press and then move his or her finger separately so as to generate either the cursor-moving signal or the scrolling signal.

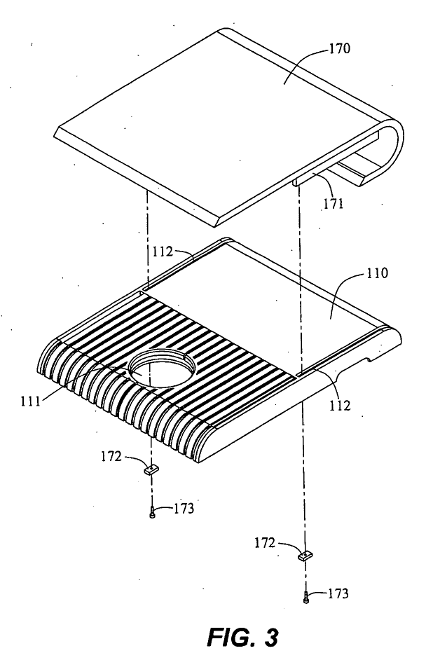

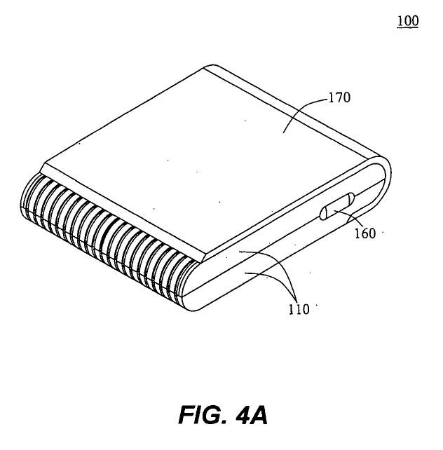

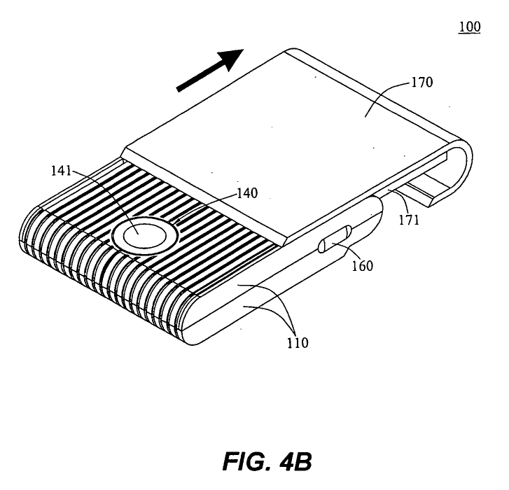

Referring to FIGS. 2, 3, 4A and 4B, the body 110 has an upper protective cover. The protective cover is movable, and has a protective position (shown in FIG. 4A) and an operating position (shown in FIG. 4B). According to the preferred embodiment, the cover 170 has a pair of racks 171 which are positioned within the corresponding pair of rails 112. Plates 172 and screws 173 can firmly secure the cover 170 on the top of the body 110 and allow the cover 170 to move from the protective position to the operating position. In addition, the cover 170 and body 110 may be combined in other ways by those skilled in the art.

When the cover 170 is at the protective position shown in FIG. 4A, the trace-detecting module 140 is protected from wear since it is under the cover 170. Once the user wishes to use the input device 100, he or she can move the cover 170 to the operating position shown in FIG. 4B.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. An immobile computer input device, comprising:
a body having at least a button;
a trace-detecting module having a light transmitting element and a light detecting unit;
a switching unit; and
a micro-controller respectively coupled to the button, the trace-detecting module and the switching unit;
wherein the trace-detecting module alternatively generates a cursor-moving signal or a scrolling signal, said trace-detecting module switching between generation of the cursor-moving signal and generation of the scrolling signal when the switching unit is activated.

2. The immobile computer input device as claimed in claim 1, wherein the detecting unit further has a light source and a sensor, said sensor detecting light reflected by said light transmitting element when an object is situated on said light transmitting element.

3. The immobile computer input device as claimed in claim 1, further comprising a movable protective cover located on top of the body and movable from an operating position in which the trace-detecting module is exposed and a protective position in which the trace-detecting module is covered.

4. The immobile computer input device as claimed in claim 3, wherein the protective cover has at least a rack positioned within a corresponding rail on the body.

5. The immobile input device as claimed in claim 1, wherein the trace-detecting module is depressable to activate a micro-switch at a side of the trace-detecting module.

6. An immobile computer input device, comprising:
at least a button:
a switching unit;
a trace-detecting module generating a first predetermined signal or a second predetermined signal; and
a micro-controller coupled to the button, the switching unit and the trace-detecting module;
wherein the trace-detecting module has a light transmitting element at a first side, and a light source and a sensor at a second side such that the light source projects lights beam toward the light transmitting element, and the sensor receives reflected light from the light transmitting element when a user's finger or other object is in contact with and moves upon the light transmitting element; and
wherein the switching unit switches between generation of the first predetermined signal and generation of the second predetermined signal upon activation of the switching unit.

7. The immobile input device as claimed in claim 6, wherein the trace-detecting module is depressable to activate a micro-switch at a side of the trace-detecting module.

8. The immobile input device as claimed in claim 6, wherein the input device further has a protective cover which can be alternatively located at an operating position and a protective position; the protective cover protecting the trace-detecting module at the protective position.
